(19) United States
(12) Patent Application Publication
(10) Pub. No.: US 2018/0246751 A1
(43) Pub. Date: Aug. 30, 2018

(54) TECHNIQUES TO SELECT VIRTUAL MACHINES FOR MIGRATION

(71) Applicant: INTEL CORPORATION, Santa Clara, CA (US)

(72) Inventors: Yao Zu DONG, Shanghai (CN); Yang ZHANG, Shanghai (CN)

(73) Assignee: INTEL CORPORATION, Santa Clara, CA (US)

(21) Appl. No.: 15/756,470

(22) PCT Filed: Sep. 25, 2015
(86) PCT No.: PCT/CN2015/090798

§ 371 Date: Feb. 28, 2018

(51) Int. Cl. G06F 9/455; G06F 9/48; G06F 9/50

(52) U.S. Cl. CPC G06F 9/45558; G06F 2009/4557; G06F 9/505; G06F 9/4856

(57) ABSTRACT

Examples may include techniques for virtual machine (VM) migration. Examples may include selecting a first VM from among a plurality of VM hosted by a source node for a first live migration to a destination node based on determined working set patterns and one or more policies.

### TECHNICAL FIELD

Examples described herein are generally related to virtual machine (VM) migration between nodes in a network.

### BACKGROUND

Live migration for virtual machines (VMs) hosted by nodes/servers is an important feature for a system such as a data center to enable fault-tolerance capabilities, flexible resource management or dynamic workload rebalancing. Live migration may include migrating a VM hosted by a source node to a destination node over a network connection between the source and destination node. The migration may be considered as live since an application being executed by the migrated VM may continue to be executed by the VM during most of the live migration. Execution may only be briefly halted just prior to copying remaining state information from the source node to the destination node to enable the VM to resume execution of the application at the destination node.

### BRIEF DESCRIPTION OF THE DRAWINGS

FIGS. 1A-D illustrate virtual machine migrations for an example first system.

FIG. 2 illustrates example first working set patterns.

FIG. 3 illustrates an example scheme.

FIG. 4 illustrates an example prediction chart.

FIG. 5 illustrates parallel virtual machine migration for an example second system.

FIG. 6 illustrates an example table.

FIG. 7 illustrates example second working set patterns.

FIG. 8 illustrates an example block diagram for an apparatus.

FIG. 9 illustrates an example of a logic flow.

FIG. 10 illustrates an example of a storage medium.

FIG. 11 illustrates an example computing platform.

### DETAILED DESCRIPTION

As contemplated in the present disclosure, live migration of a VM from a source node/server to a destination node/server may be considered as live as the application being executed by the VM may continue to be executed by the VM during most of the live migration. A large portion of a live migration of a VM may be VM state information that includes memory used by the VM while executing the application. Therefore, live migration typically involves a two-phase process. The first phase may be a pre-memory copy phase that includes copying initial memory (e.g., for a 1^{st} iteration) and changing memory (e.g., dirty pages) for remaining iterations from the source node to the destination node while the VM is still executing the application or the VM is still running on the source node. The first or pre-memory phase may continue until remaining dirty pages at the source node fall below a threshold. The second phase may then be a stop-and-copy phase that stops or halts the VM at the source node, copies remaining state information (e.g., remaining dirty pages and/or processor state, input/output state) to the destination node, and then resumes the VM at the destination node. The copying of VM state information for the two phases may be through a network connection maintained between the source and destination node.

The amount of time spent in the second, stop-and-copy phase is important as the application is not being executed by the VM for this period of time. Thus, any network services being provided while executing the application may be temporarily unresponsive. The amount of time spent in the first pre-memory copy phase is also important since this phase may have the greatest time impact on the overall time to complete the live migration. Also, live migration expends relatively high amounts of computing resources so performance of other VMs running on the source or destination node may be heavily impacted.

A significant challenge to VM migration may be associated with a memory working set of the VM as the VM executes one or more applications. If a rate of dirtied memory pages is larger than a rate of an allocated network bandwidth for the VM migration then it may take an unacceptably long time to halt execution of the one or more applications at the stop-and-copy phase as a large amount of data may still remain to be copied from the source node to the destination node. This unacceptably long time is problematic to VM migration and may lead to a migration failure.

One way to reduce live migration times is to increase the allocated network bandwidth for VM migration. However, network bandwidth may be limited and wise use of this limited resource may be necessary to meet various performance requirements associated with quality of service (QoS) criteria or service level agreements (SLAs) that may be associated with operating a data center. Selectively choosing which VM to migrate and also possibly the time of day for such migration may enable a more efficient use of valuable allocated network bandwidth and may enable a live migration that has an acceptably short time period for a stop-and-copy phase. Also, additional source node resources such processing resources may be tied or allocated during a migration and the longer these resources are allocated the greater an impact on overall performance for the source node and possibly the destination node as well.

Also, data centers as well as cloud vendors may use large numbers of nodes/servers that may each support many VMs. Often, workloads being carried out by respective VMs may support network services demanding high availability across hardware life cycles. Techniques such as hardware redundancy based RAS (reliability, availability and serviceability) features may be used to provide hints when hardware associated with a node/server (e.g., CPUs, memory, network input/output, etc.) is coming close to an end-of-life cycle. These hints may allow for VMs to be migrated from a potentially failing source node/server to a destination node/server before the end-of-life cycle actually occurs.

Live migration techniques such as those mentioned above may be used to move all VMs from a near end-of-life cycle source node/server to a more dependable (e.g., farther from end-of-life cycle) destination node/server. Following live VM migration of all VMs to the destination node/server the source node/server may be retired. However, determining a sequence of what order to live migrate VMs from the source node/server to the destination node/server and doing so with little to no disruption in supported network services is difficult. Therefore a need exists for determining a sequence of migrating VMs such that high availability or RAS requirements can be met when operating large numbers of nodes/servers supporting many VMs. It is with respect to these challenges that the examples described herein are needed.

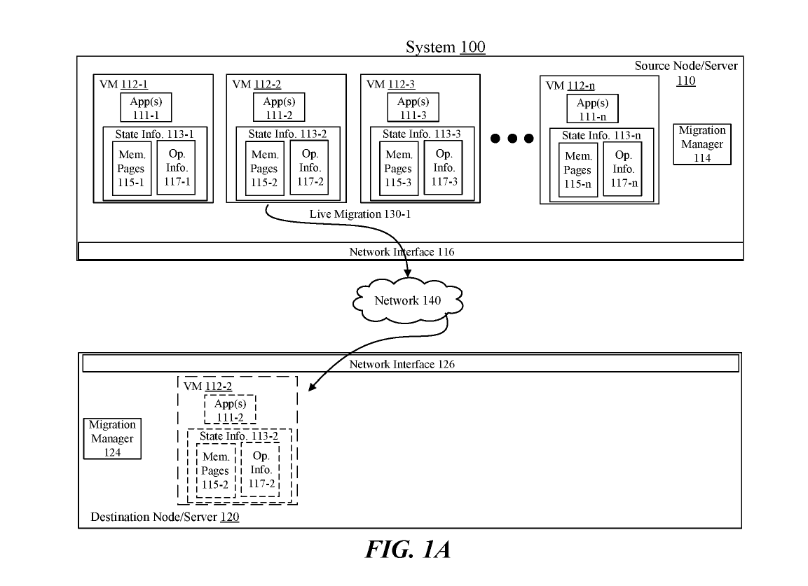

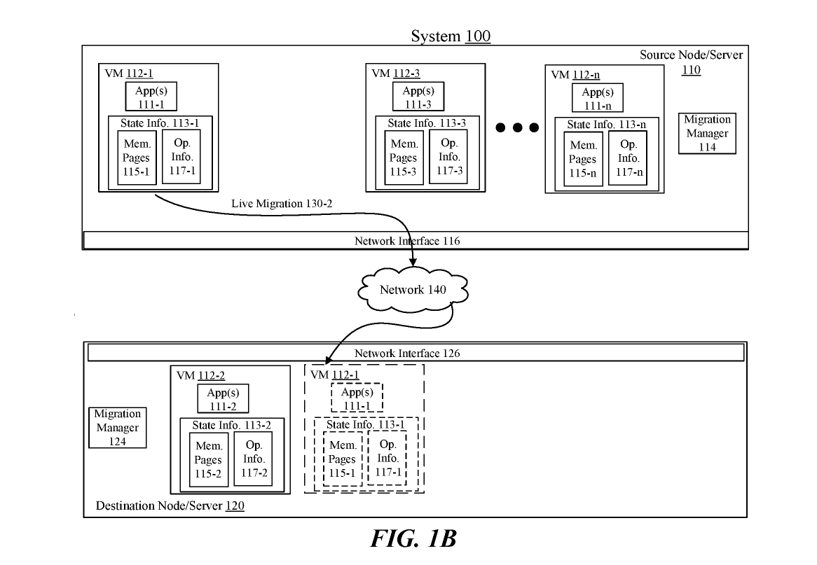

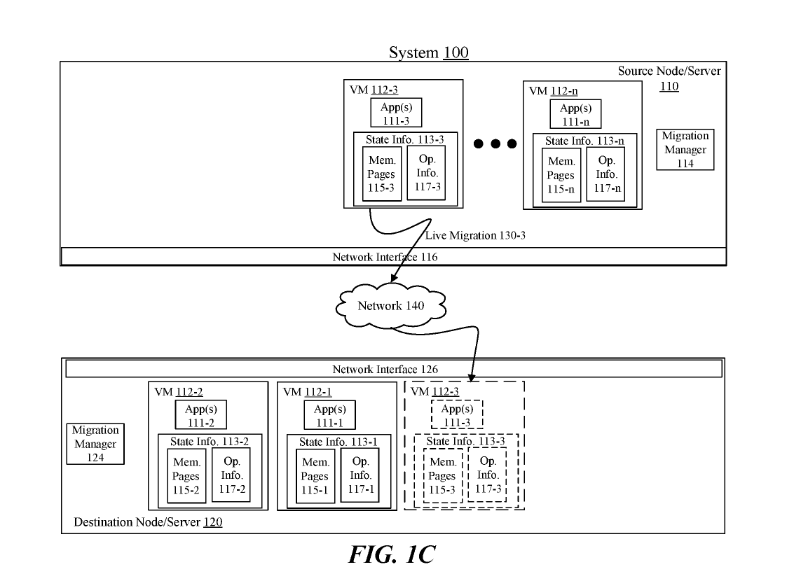

FIGS. 1A-D illustrate VM migrations for an example system 100. In some examples, as shown in FIG. 1A, system 100 includes a source node/server 110 that may be communicatively coupled with a destination node/server 120 through a network 140. Source node/server 110 and destination node/server 120 may be arranged to host a plurality of VMs. For example, source node/server 110 may host VMs 112-1, 112-2, 112-3 to 112-n, where “n” is any whole positive integer greater than 3. Destination node/server 120 may also be capable of hosting multiple VMs to be migrated from source node/server 110. Hosting may include providing composed physical resources such as processors, memory, storage or network resources (not shown) maintained at or accessible to respective source node/server 110 or destination node/server 120. Both source node/server 110 and destination node/server 120 may include respective migration managers 114 and 124 to facilitate migration of VMs between these nodes. Also, in some examples, system 100 may be part of a data center arranged to provide Infrastructure as a Service (IaaS), Platform as a Service (PaaS) or Software as a Service (SaaS).

In some examples, as shown in FIG. 1A, VMs 112-1, 112-2, 112-3 and VM 122-n may be capable of executing respective one or more applications (App(s)) 111-1, 111-2, 111-3 and 111-n. Respective state information 113-1, 113-2, 113-3 and 113-n for App(s) 111-1, 111-2, 111-3 and 111-n may reflect a current state of respective VMs 112-1, 112-2, VM112-3 and VM 122-n for executing these one or more applications in order to fulfill a respective workload. For example, state information 113-1 may include memory pages 115-1 and operating information 117-1 to reflect the current state of VM 112-1 while executing App(s) 111-1 to fulfill a workload. The workload may be a network service associated with providing IaaS, PaaS or SaaS to one or more clients of a data center that may include system 100. The network service may include, but is not limited to, database network service, website hosting network services, routing network services, e-mail network services or virus scanning network services. Performance requirements for providing an IaaS, a PaaS or a SaaS to the one or more clients may include meeting one or more quality of service (QoS) criteria, service level agreement (SLAs) and/or RAS requirements.

In some examples, logic and/or features at source node/server 110 such as migration manager 114 may be capable of selecting a first VM from among VMs 112-1 to 112-n for a first live migration. The selection may be due to indications that source node/server 110 is approaching an end-of-life cycle or may be starting to show signs of premature failure, e.g., unable to meet QoS criteria or SLAs when hosting VMs 112-1 to 112-n. These indications of an end-of-life cycle or premature failure may result in a need to orderly migrate VMs 112-1 to 112-n from source node/server 110 to destination node/server 120 while having little to no impact on providing network services and thus maintaining high availability for system 100. Examples are not limited to these reasons for live migration of VMs from one node/server to another node/server. Other example reasons for a live migration are contemplated by this disclosure.

According to some examples, migration manager 114 may include logic and/or features to implement prediction algorithms to predict migration behaviors for selectively migrating VMs 112-1 to 112-n to destination node/server 120. The prediction algorithms may include determining separate predicted times for each VM to copy dirty memory pages to destination node/server 120 until remaining dirty memory pages fall below a threshold number (e.g., similar to completing a pre-memory copy phase). The separately predicted time periods may be based on respective VMs executing their respective applications to fulfill respective workloads. As described more below, these respective workloads may be used to determine separate working set patterns that are then used to predict VM migration behaviors based on network bandwidth allocated for VM migration. A first VM from among VM's 112-1 to 112-n may then be selected to be first of the VMs migrated to destination node/server 120 based on its migration behavior satisfying one or more policies compared to other separately predicted VM migration behaviors for the other VMs.

In some examples, the one or more policies used to select the first VM to be the first of the VMs migrated may include a first policy of least impact on a given VM fulfilling its respective workload during live migration compared to other VMs. The one or more policies may also include a second policy based on a lowest amount of network bandwidth needed for live migration of the given VM compared to other VMs. The one or more policies may also include a third policy of shortest time for the given VM to live migrate to destination node/server 120 compared to the other VMs. The one or more policies are not limited to the first, second or third policies mentioned above, other policies are contemplated that compare VM migration behaviors and select the given VM that may best meet QoS, SLA or RAS requirements.

According to some examples, FIG. 1A illustrates an example of a live migration 130-1 that includes a first live migration of VM 112-2 to destination node/server 120 over network 140. For these examples, a predicted time period for live migration 130-1 may be an amount of time until remaining dirty memory pages from memory pages 115-2 fall below the threshold number. The predicted time period associated with migration behavior of VM 112-2 may also be based on VM 112-2 executing App(s) 111-2 to fulfill a given workload that may follow a determined working set pattern for the rate of generation of dirty memory pages from memory pages 115-2. The determined working set pattern may be based, at least in part, on allocated resources from composed physical resources (e.g., processors, memory, storage or network resources) available to VMs such as VM 112-2 hosted by source node/server 110.

In some examples, as shown in FIG. 1A, live migration 130-1 may be routed through network interface 116 at source node/server 110, over network 140 and then through network interface 126 at destination node/server 120. For these examples, network 140 may be part of an internal network for a data center that may include system 100. As described more below, a certain amount of allocated network bandwidth from a limited amount of available network bandwidth maintained by or available to source node/server 110 may be needed to enable live migration 130-1 to be completed in an acceptable amount of time through network 140. Some or all of that allocated bandwidth may be pre-allocated for supporting VM migration or some or all of that allocated bandwidth may be borrowed from other VMs hosted by source node/server 110 at least until live migration 130-1 is completed.

According to some examples, the threshold number for the remaining dirty pages to be copied to destination node/server 120 may be based on an ability of source node/server 110 to copy to destination node/server 120 remaining dirty pages from memory pages 115-2 and copy at least processor and input/output states included in operation information 117-2 within a shutdown time threshold (e.g., similar to a stop-and-copy phase) utilizing an allocated network bandwidth allocated by source node/server 110 for live migration of one or more VMs at a given time. The shutdown time threshold may be based on a requirement for VM 112-2 to be stopped at source node/server 110 and resume at destination node/server 120 within a given time period. The requirement for VM 112-2 to stop and resume at destination node/server 120 within the shutdown time threshold may be set for meeting one or more QoS criteria, an SLA and/or RAS requirements. For example, the requirement may dictate a shutdown time threshold of less than a couple milliseconds.

In some examples, migration manager 114 may also include logic and/or features that determines that VM 112-2 as well as VMs 112-1 and 112-3 to 112-n each have separate predicted VM migration behaviors for a first live migration that indicates remaining dirty memory pages fail to fall below the threshold number of remaining dirty memory pages. For these examples, the logic and/or features of migration manager 114 may determine what additional network bandwidth is needed to enable remaining dirty memory pages for VM 112-2 to fall below the threshold number of remaining dirty memory pages. The logic and/or features of migration manager 114 may then select at least one VM from among VMs 112-1 or 112-3 to 112-n to borrow allocated network bandwidth for VM 112-2 to copy dirty memory pages to destination node/server 120 until remaining dirty memory pages fall below the threshold number within a predicted time period determined based on VM 112-2's predicted VM migration behavior. For these examples, VMs 112-1 and 112-3 to VM 112-n may each be allocated a portion of source node/server 110's network bandwidth. The borrowed amount of allocated network bandwidth may include all or at least a portion of the borrowed VM's allocated network bandwidth. Migration manager 114 may combine the borrowed allocated network bandwidth with network bandwidth already allocated to facilitate live migration 130-1 of VM 112-2 to destination node/server 120.

According to some examples, other resources such as processing, memory or storage resources may also be borrowed from allocations made to other VMs to facilitate live migration 130-1 of VM 112-2 to destination node/server 120. This borrowing may occur for similar reasons as mentioned above for borrowing network bandwidth. In some cases, the other resources may be borrowed to provide a margin of extra resources to ensure live migration 130-1 is successful (e.g., meets QoS, SLA or RAS requirements). For example, the margin may include, but is not limit to, at least an extra 20% of what is needed to ensure live migration 130-1 is successful, e.g., additional processing and/or networking resources to speed up copying of dirty memory pages to destination node/server 120.

In some examples, migration manager 114 may also include logic and/or features to reduce an amount of allocated processing resources for a given VM such as VM 112-2. For these examples, VM 112-2's predicted migration behavior may indicate that VM 112-2 executing App(s) 113-2 generates dirty memory pages at a rate faster than those dirty pages can be copied to destination node/server 120 such that remaining dirty pages and processor and input/output states for VM 112-2 to execute App(s) 113-2 at destination node/server 120 cannot be copied to destination node/server 120 within a shutdown time threshold. In other words, a convergence point is unable to be reached that enables VM 112-2 to shutdown at source node/server 110 and restart at destination node/server 110 within an acceptable amount of time that is reflected in the shutdown time threshold. For these examples, in order to slow down the rate of dirty memory page generation to reach the convergence point, logic and/or features of migration manager 114 may cause allocated processing resources for VM 112-2 to be reduced such that remaining dirty memory pages fall below a threshold number of remaining dirty memory pages. Once below the threshold number, remaining dirty memory pages and processor and input/output states for VM 112-2 to execute App(s) 113-2 may then be copied to destination node/server 120 within the shutdown time threshold using allocated and/or borrowed network resources during live migration 130-1.

According to some examples, FIG. 1B illustrates an example of a live migration 130-2 for a second live migration of VM 112-1 selected from the remaining VMs at source node/server 110. For these examples, migration manager 114 may include logic and/or features to determine working set patterns for respective remaining VMs 112-1 and 112-3 to 112-n based on VM 112-2 already being live migrated to destination node/server 120 and based on these remaining VMs separately executing their respective applications to fulfill respective workloads. The logic and/or features of migration manager 114 may predict respective VM migration behaviors for VMs 112-1 and 112-3 to 112-n based on the determined working set patterns and based on network bandwidth now available for the second live migration The network bandwidth now available may be a combined network bandwidth of the network bandwidth previously available for live migration 130-1 to migrate VM 112-2 and network bandwidth that was allocated to VM 112-2 prior to the completion of live migration 130-1. In other words, the network bandwidth previously used by VM 112-2 at source node/server 110 is now available for use in migrating VMs to destination node/server 120. This added network bandwidth likely changes VM migration behaviors for the remaining VMs.

In some examples, the logic and/or features of migration manager 114 may select VM 112-1 for live migration 130-2 based on VM 112-1's predicted VM migration behavior satisfying the above-mentioned one or more policies compared to other separately predicted VM migration behaviors for VMs 112-3 to 112-n that are still remaining at source node/server 110.

According to some examples, FIG. 1C illustrates an example of a live migration 130-3 for a third live migration of VM 112-3 selected from the remaining VMs at source node/server 110. For these examples, migration manager 114 may include logic and/or features to determine working set patterns for respective remaining VMs 112-3 to 112-n based on VMs 112-1 and 112-2 already being live migrated to destination node/server 120 and based on these remaining VMs separately executing their respective applications to fulfill respective workloads. The logic and/or features of migration manager 114 may predict respective VM migration behaviors for VMs 112-3 to 112-n based on the determined working set patterns and based on network bandwidth now available for the third live migration The network bandwidth now available may be a combined network bandwidth of the network bandwidth previously available for live migrations 130-1 and 130-2 to migrate VM 112-2 and network bandwidth that was allocated to VM 112-1 prior to the completion of live migration 130-2. Similar to what was mentioned above for live migration 130-2, this added network bandwidth likely changes VM migration behaviors for the remaining VMs.

In some examples, the logic and/or features of migration manager 114 may select VM 112-3 for live migration 130-3 based on VM 112-3's predicted VM migration behavior satisfying the above-mentioned one or more policies compared to other separately predicted VM migration behaviors for VM(s) 112-n that are still remaining at source node/server 110.

According to some examples, FIG. 1D illustrates an example of a live migration 130-n for an nth live migration of the last remaining VM at source node/server 110. For these examples, following migration of the last remaining VM to destination node/server 120, source node/server 110 may be taken offline.

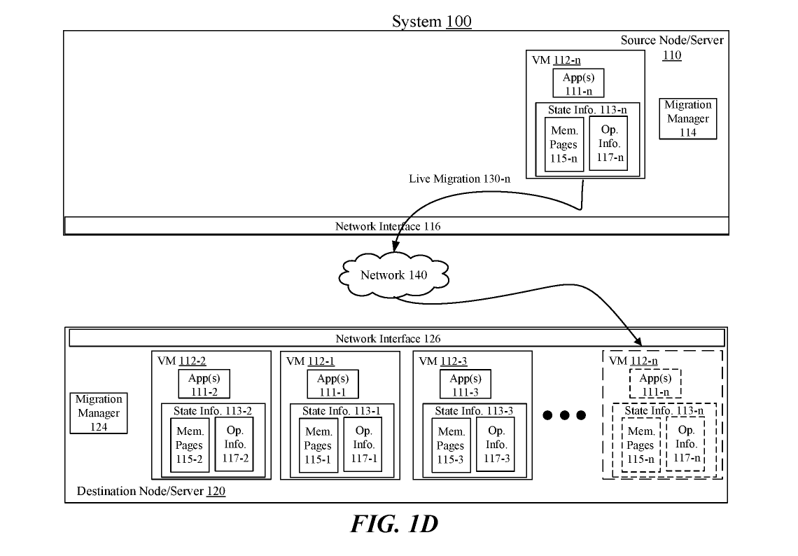

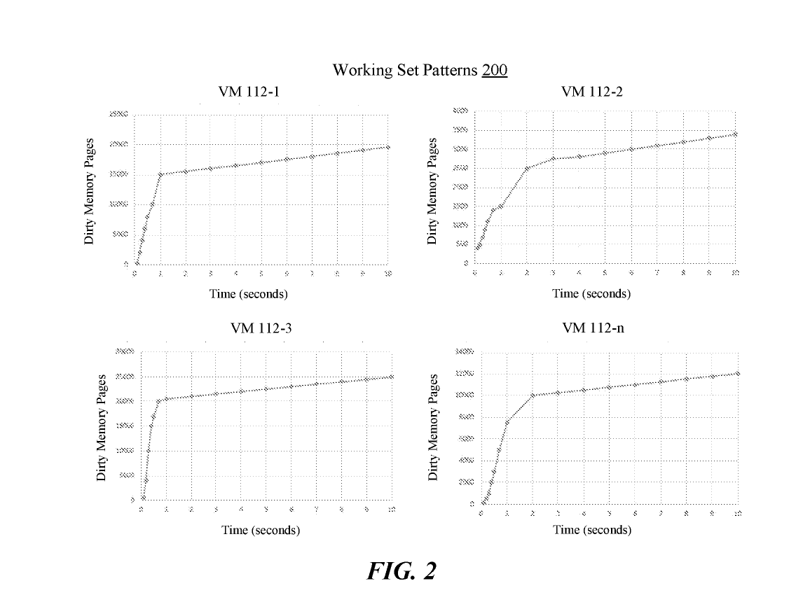

FIG. 2 illustrates example working set patterns 200. In some examples, working set patterns 200 may include separately determined working set patterns for VMs 112-1 to 112-n hosted by source node/server 110 as shown in FIG. 1 for system 100. For these examples, the separately determined working set patterns may be based on respective VMs 112-1 to 112-n separately executing respective applications 113-1 to 113-n to fulfill respective workloads. Each of the working set patterns included in working set patterns 200 may be based on collecting a writable (memory) working-set pattern using a log-dirty mode to track a number of dirty memory pages over a given time for each VM. The use of the log-dirty mode for each VM may be used to track dirty pages during a previous iteration that may occur during a live migration of each VM. In other words, as dirty pages are being copied from a source node/server to a destination node/server, new dirty pages generated during this period or iteration may be generated. The log-dirty mode may set write-protection to memory pages for a given VM and set a data structure (e.g., a bitmap, hash table, log buffer or page modification logging) to indicate a dirty status of a given memory page at a time of fault (e.g., VM exit in system virtualization), when the given VM writes to the given memory page. Following the write to the given memory page, the write-protection is removed for the given memory page. The data structure may be checked periodically (e.g., every 10 milliseconds) to determine a total number of dirty pages for the given VM.

In some examples, as shown in FIG. 2 for working set patterns 200, following an initial burst in the number of dirty memory pages at the start, the rate of dirty memory page generation somewhat levels off for determined work set patterns for each of the VMs. According to some examples, the generation of dirty memory pages for a given determined working set pattern from among working set patterns 200 may be described using example equation 1:

D=ƒ(t) (1)

For example equation 1, D represents dirty memory pages generated and ƒ(t) represents a monolithically increasing function. Therefore, eventually all memory provisioned to a VM for executing an application that fulfills a workload having working set pattern 200 would go from 0 dirty memory pages to substantially all provisioned memory pages being dirty.

In some examples, an assumption may be made that D=ƒ(t) for working set patterns may remain constant during a live VM migration process. Therefore, a working set pattern having D=ƒ(t) that was tracked during a previous iteration may be the same for a current iteration. Even if a workload may fluctuate during a given 24-hour day, resampling or tracking of the workload to determine working set patterns reflecting fluctuating workloads may be needed. For example, tracking may occur every 30 minutes or every hour to determine what D=ƒ(t) will apply for use in migrating a given VM. For example, if a workload is high for a first portion of a 24-hour day compared to a second portion of a 24-hour day, more dirty memory pages may be generated for each iteration and thus live migration of the given VM may need to account for this increase in the rate of dirty memory page generation.

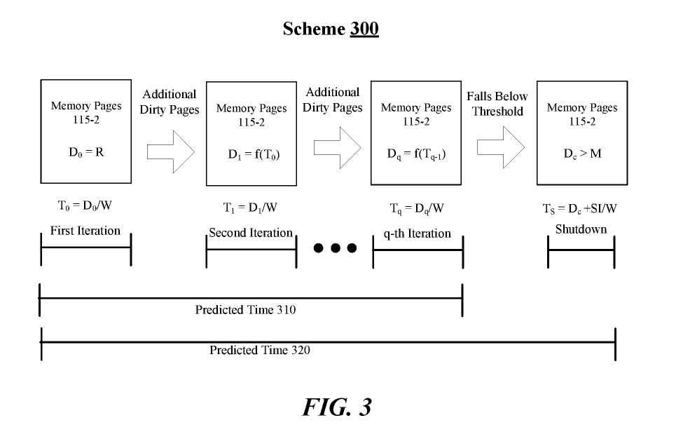

FIG. 3 illustrates an example scheme 300. In some examples, scheme 300 may depict an example of VM migration behavior for a live migration that includes multiple copy iterations that may be needed to copy dirty memory pages generated as a VM such as VM 112-2 of source node/server 110 executes an application while being migrated to destination node/server 120 as part of live migration 130-1 shown in FIG. 1. For these examples, all memory pages provisioned to VM 112-2 may be represented by “R”. As shown in FIG. 3 for the start of first iteration of scheme 300 at least part or all of R memory pages may be considered as dirty as represented by example equation (2) of D₀=R. In other words, according to example equation (2) and as shown in FIG. 3, at least part or all of R memory pages may be copied to destination node/server 120 during the first iteration.

According to some examples, a time period to complete the first iteration may be determined using example equation (3):

T₀=D₀/W (3)

For example equation (3), W may represent allocated network bandwidth (e.g., in megabytes per second (MBps)) to be used to migrate VM 112-2 to destination node/server 120.

At the start of the second iteration, newly generated dirty pages produced by VM 112-2 executing App(s) 111-2 while fulfilling the workload during T₀ may be represented by example equation (4):

D₁=ƒ(T₀) (4)

The time period to copy D₁ dirty memory pages may be represented by example equation (5):

T₁=D₁/W (5)

Therefore, the number of dirty memory pages at the start of the q-th iteration, where “q” is any positive whole integer>1, may be represented by example equation (6):

D_{q}=ƒ(T_{q-1}) (6)

The time period to copy Dq dirty memory pages may be represented by example equation (7):

T_{q}=D_{q}/W (7)

In some examples, M may represent a threshold number of remaining dirty memory pages remaining at source node/server 110 that may trigger an end of a pre-memory copy phase and a start of a stop-and-copy phase that includes stopping VM 112-2 at source node/server 110 and then copying remaining dirty memory pages of memory 115-2 as well as operating state information 117-2 to destination node/server 120. For these examples, equation (8) represents a condition of convergence for which the number of remaining dirty memory pages falls below M:

∃iDᵢM (8)

Therefore, the number of remaining dirty pages at convergence may be represented by Dc and example equation (9) of D_{c}<M indicates that the number of remaining dirty pages has fallen below the threshold number of M.

The time period to copy Dc during the stop-and-copy phase may be represented by example equation (10):

T_{S}=(D_{c}+SI)/W (10)

For example equation (10), SI represents the operating state information included in operating state information 117-2 for VM 112-2 that existed at the time that VM 112-2 was stopped at source node/server 110.

According to some examples, predicted time 310 as shown in FIG. 3 indicates the amount of time for the remaining dirty memory pages to fall below the threshold number of M. As shown in FIG. 3, this includes a summation of time periods T₀, T₁ to T_{q}. Predicted time 320, as shown in FIG. 3 indicates a total time to migrate VM 112-2 to destination node/server 120. As shown in FIG. 3, this includes a summation of time periods T₀, T₁ to T_{q} and Ts.

In some examples, threshold M may be based on an ability of VM 112-2 to be stopped at source node/server 110 and restarted at destination node/server 120 within a shutdown time threshold based on using an allocated network bandwidth W for the live migration of VM 112-2.

In some examples, all of the allocated network bandwidth W may be borrowed from another VM hosted by source node/server 110. In other examples, a first portion of the allocated network bandwidth W may include pre-allocated network bandwidth reserved for live migration (e.g., for any VM hosted by source node/server 110) and a second portion may include borrowed network bandwidth borrowed from another VM hosted by source node/server 110.

In some examples, the shutdown time threshold may be based on a requirement for VM 112-2 to be stopped at source node/server 110 and be restarted at destination node/server 120 within a given time period. For these examples, the requirement may be set for meeting one or more QoS criteria, SLA requirements and/or RAS requirements.

According to some examples, the predicted migration behavior determined using scheme 300 for VM 112-2 may satisfy one or more policies compared to other separately predicted VM migration behaviors for other VMs also determined using scheme 300. These other VMs may include VMs 112-1 and 112-3 to 112-n hosted by node/server 110. As mentioned previously, these one or more policies may include, but are not limited to, a first policy of least impact on a given VM fulfilling its respective workload during live migration compared to other VMs, a second policy based on a lowest amount of network bandwidth needed for live migration of the given VM compared to other VMs or a third policy of shortest time for the given VM to live migrate to destination node/server 120 compared to the other VMs.

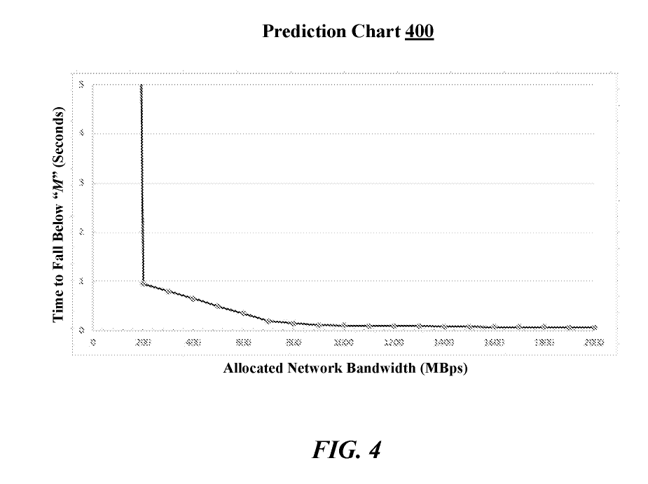

FIG. 4 illustrates an example prediction chart 400. In some examples, prediction chart 400 may show predicted times to fall below M number of remaining memory pages based on what allocated network bandwidth is used for live migration of a VM. Prediction chart 400, for example, may be based on use of example equations (1) through (9) using various different values for allocated network bandwidth and also based on a VM executing one or more applications to fulfill a workload having a working set pattern that determines D=ƒ(t).

As shown in FIG. 4 for prediction chart 400, convergence (time to fall below M) in under 5 seconds does not appear to occur until at least 200 MBps is allocated for migration of the VM. Also, at allocated network bandwidths of over 800 MBps no appreciable time benefits associated with allocating more bandwidth is shown.

According to some examples, prediction chart 400 may be used to determine VM migration behavior for a given VM and various different allocated network bandwidths for a given determined working set pattern. Separate prediction charts similar to prediction chart 400 may be generated for each VM hosted by a source node/server to compare migration behaviors in order to select which VM is to be the first VM live migrated to a destination source node/server.

In some examples, Prediction chart 400 may also be used to determine what allocated network bandwidth would be needed for migrating a selected VM from the source node/server to a destination node/server. For example, if the network bandwidth currently allocated for the first live migration is 200 MBps and QoS, SLA and/or RAS requirements set a threshold of 0.5 seconds to fall below “M” then prediction chart 400 indicates that at least 600 MBps of allocated network bandwidth is needed. Thus, for this example, an additional 400 MBps needs to be borrowed from non-migrated or remaining VMs in order to meet the QoS, SLA and/or RAS requirements.

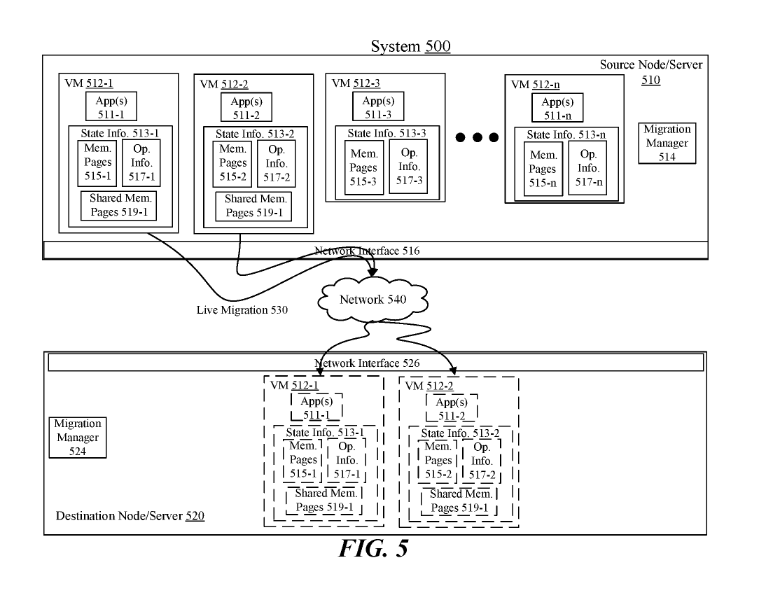

FIG. 5 illustrates an example system 500. In some examples, as shown in FIG. 5, system 500 includes a source node/server 510 that may be communicatively coupled with a destination node/server 520 through a network 540. Similar to system 100 shown in at least FIG. 1A, source node/server 510 and destination node/server 520 may be arranged to host a plurality of VMs. For example, source node/server 510 may host VMs 512-1, 512-2, 512-3 to 512-n. Destination node/server 520 may also be capable of hosting multiple VMs to be migrated from source node/server 510. Both source node/server 510 and destination node/server 520 may include respective migration managers 514 and 524 to facilitate migration of VMs between these nodes.

In some examples, as shown in FIG. 5, VMs 512-1, 512-2, 512-3 and VM 522-n may be capable of executing respective one or more applications (App(s)) 511-1, 511-2, 511-3 and 511-n. Respective state information 513-1, 513-2, 513-3 and 513-n for App(s) 511-1, 511-2, 511-3 and 511-n may reflect a current state of respective VMs 512-1, 512-2, 512-3 and VM 522-n for executing these one or more applications in order to fulfill a respective workload.

In some examples, at least two VMs hosted by a node may have state information that includes shared memory pages. These shared memory pages may be associated with shared data between the one or more applications executed by the at least two VMs will fulfilling their separate but possibly related workloads. For example, state information 513-1 and 513-2 for respective VM 512-1 and 512-2 includes shared memory pages 519-1 used by App(s) 511-1 and 511-2. For these examples, these at least two VMs may need to be migrated in parallel in order to ensure their respective state information is migrated almost simultaneously.

According to some examples, logic and/or features included in migration manager 514 may select VMs 512-1 and 512-2 for live migration 530 based on this pair of VMs having a predicted migration behavior satisfying one or more policies as compared to other separately predicted migration behaviors for VMs 512-3 to 512-n. These separately predicted migration behaviors for the VM pair of VMs 512-1/512-2 and for VMs 512-3 to 512-n may be determined based on a scheme similar to scheme 300 mentioned above.

In some examples, the one or more policies may include, but are not limited to, a first policy of least impact on a given VM or group of VMs fulfilling respective workload(s) during live migration compared to other VMs, a second policy based on a lowest amount of network bandwidth needed for live migration of the given VM or group of VMs compared to other VMs or a third policy of shortest time for the given VM or group of VMs to live migrate to destination node/server 120 compared to the other VMs.

According to some examples, logic and/or features included in migration manager 514 may select VMs 512-1 and 512-2 for live migration 530 based on this pair of VMs having a predicted migration behavior satisfying the first policy, the second policy, the third policy or a combination of the first, second or third policies as compared to other separately predicted migration behaviors for VMs 512-3 to 512-n.

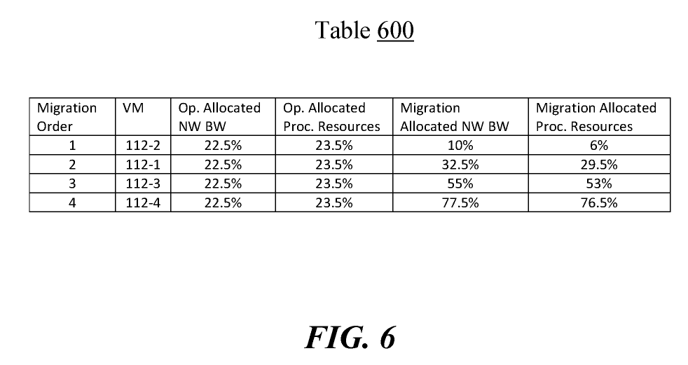

FIG. 6 illustrates an example table 600. In some examples, as shown in FIG. 6 table 600 shows an example migration order for live migration of VMs 112-1 to 112-n. Table 600 also shows how resources may be reallocated following each live migration of VMs for subsequent use for a next live migration. For example, as mentioned above for system 100 for FIGS. 1-3, VM 112-2 may have been selected as the first VM to be migrated to destination node/server 120.

In some examples, as shown in table 600 VM 112-2 may have been allocated operating (op.) allocated network (NW) bandwidth (BW) of 22.5% by source node/server 110. This op. allocated NW BW may be available for use by VM 112-2 when executing App(s) 111-2 to fulfill a workload. Also, for examples where n=4 the other VMs 112-1, 112-3 and 112-4 may have respective op. allocated NW BWs of 22.5%. Thus, for these examples, a total of 90% of NW BW is allocated to these four VMs for use when executing their respective one or more applications to fulfill their respective workloads. A similar, equal allocation of op. allocated processing (proc.) resources may made to VMs 112-1 to 112-4 that has 23.5% allocated to each VM for a total of 95% of proc. resources being allocated to these four VMs for use when executing their respective one or more applications to fulfill their respective workloads.

According to some examples, table 600 indicates that for the first live migration of VMs 112-1 to 112-4 is for the live migration of VM 112-2 (migration order 1). For this first live migration a migration allocated NW BW of 10% is available. Also, table 600 indicates that 6% of proc. resources are available for the first migration of VM 112-2. These allocated percentages for the first migration include the full remaining portion of NW BW and proc. resources not allocated to the four VMs for use to fulfill workloads. Although in other examples, less than the full remaining portions of NW BW and/or proc. resources may be allocated for the first migration.

In some examples, table 600 indicates that for the second live migration of the remaining VMs is for the live migration of VM 112-1 (migration order 2). For this second live migration a migration allocated NW BW has been increased from 10% to 32.5% due to VM 112-2 NW BW now being reallocated for use in the second live migration. Also, table 600 indicates that proc. resources available for the second migration of VM 112-1 has increased from 6% to 29.5% for similar reasons as mentioned for the reallocated NW BW.

According to some examples, table 600 also indicates reallocation of NW BW and proc. resources for the third and fourth live migrations of the remaining VMs following a similar pattern as mentioned above for the second live migration. The reallocation of NW BW and proc. resources as shown in table 600 may result in each subsequent live migration of remaining VMs having higher and higher allocations of NW BW and proc. resources. In addition to selecting VMs for first, second, third, etc. live migrations based on satisfying one or more policies, these higher and higher allocations of NW BW and proc. resources may enable migration manager 114 to further implement an orderly and efficient migration of VMs from source node/server 110 to destination node/server 120.

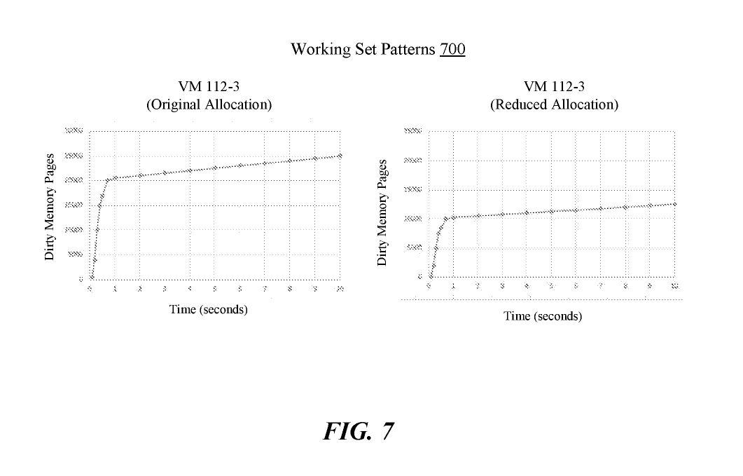

FIG. 7 illustrates example working set patterns 700. In some examples, as shown in FIG. 7, working set patterns 700 includes a first working set pattern for VM 112-3 (original allocation) that is the same working set pattern included in working set patterns 200 shown in FIG. 2. For these examples, working set patterns 700 includes a second working set pattern for VM 112-3 (reduced allocation) that shows how a working set pattern may be impacted if processing resources allocated to a given VM are reduced to cut down the rate at which dirty memory pages are generated.

According to some examples, VM 112-3 op. allocated proc. resources of 23.5% as shown in table 600 may be reduced (e.g., cut in half to around 12%) such that the rate of dirty memory page generation is approximately cut in half. For these examples, this reduction may be based on a predicted migration behavior for VM 112-3 indicating that VM 112-3 executing one or more applications (e.g., App(s) 113-2) generates dirty memory pages at a rate that is at least twice as fast as those dirty pages can be copied to destination node/server 120 within a shutdown time threshold. As shown in FIG. 7, the working set pattern for the reduced allocation has a curve that reaches around 12,500 dirty memory pages after 10 seconds vs. reaching around 25,000 dirty memory pages before the reduced allocation.

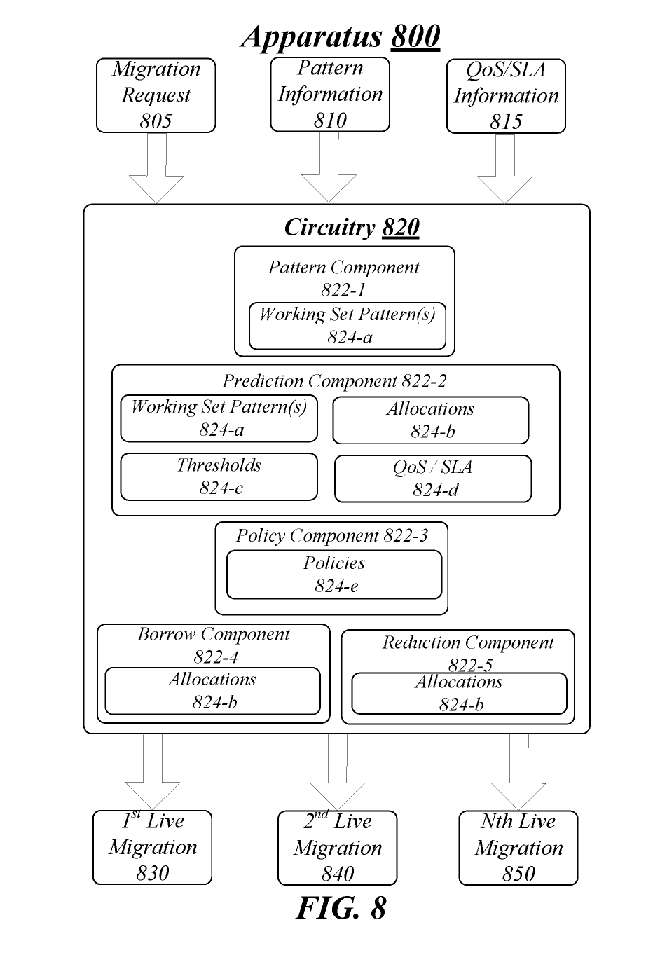

FIG. 8 illustrates an example block diagram for an apparatus 800. Although apparatus 800 shown in FIG. 8 has a limited number of elements in a certain topology, it may be appreciated that the apparatus 800 may include more or less elements in alternate topologies as desired for a given implementation.

According to some examples, apparatus 800 may be supported by circuitry 820 maintained at a source node/server arranged to host a plurality of VMs. Circuitry 820 may be arranged to execute one or more software or firmware implemented modules or components 822-a. It is worthy to note that “a” and “b” and “c” and similar designators as used herein are intended to be variables representing any positive integer. Thus, for example, if an implementation sets a value for a=5, then a complete set of software or firmware for components 822-a may include components 822-1, 822-2, 822-3, 822-4 or 822-5. The examples presented are not limited in this context and the different variables used throughout may represent the same or different integer values. Also, these “components” may be software/firmware stored in computer-readable media, and although the components are shown in FIG. 8 as discrete boxes, this does not limit these components to storage in distinct computer-readable media components (e.g., a separate memory, etc.).

According to some examples, circuitry 820 may include a processor or processor circuitry to implement logic and/or features to facilitate migration of VMs from a source node/server to a destination node/server (e.g., migration manager 114). As mentioned above, circuitry 820 may be part of circuitry at a source node/server (e.g., source node/server 110) that may include processing cores or elements. The circuitry including one or more processing cores can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Atom®, Celeron®, Core (2) Duo®, Core i3, Core i5, Core i7, Itanium®, Pentium®, Xeon®, Xeon Phi® and XScale® processors; and similar processors. According to some examples circuitry 820 may also include an application specific integrated circuit (ASIC) and at least some components 822-a may be implemented as hardware elements of the ASIC.

According to some examples, apparatus 800 may include a pattern component 822-1. Pattern component 822-1 may be executed by circuitry 820 to determine separate working set patterns for respective VMs hosted by a source node, the separate working set patterns based on the respective VMs separately executing one or more applications to fulfill respective workloads. For these examples, pattern component 822-1 may determine the working set patterns responsive to a migration request 805 and based on information included in pattern information 810 that indicates respective rates for which the respective VMs generate dirty memory pages as the respective VMs are separately executing one or more applications to fulfill respective workloads. The separate working set patterns may be included in working set pattern(s) 824-a maintained in a data structure such as a lookup table (LUT) accessible to pattern component 822-1.

In some examples, apparatus 800 may also include a prediction component 822-2. Predict component 822-2 may be executed by circuitry 820 to predict a VM migration behavior of a first VM of the respective VMs to a destination node based on a working set pattern of the first VM determined by pattern component 822-1 (e.g., included in working set pattern(s) 824-a) and based on a first network bandwidth allocated for a first live migration of at least one of the respective VMs to the destination node. For these examples, prediction component 822-2 may have access to information included in working set pattern(s) 824-a, allocations 824-b, thresholds 824-c and QoS/SLA 824-d to predict the VM migration behavior of the first VM. Similar to working set pattern(s) 824-a, the information included in allocations 824-b, thresholds 824-c and QoS/SLA 824-d may be maintained in data structures such as LUTs accessible to predict component 822-2. Also, for these examples, QoS/SLA information 815 may include information that sets thresholds 824-c and/or is included in QoS/SLA 824-d.

In some examples, prediction component 822-2 may predict VM migration behavior of the first VM for the live migration of the first VM to the destination node such that the working set pattern of the first VM determined by pattern component 822-1 may be used to determine how many copy iterations are needed to copy dirty memory pages to the destination node during the first live migration given at least the first network bandwidth allocated for the first live migration until remaining dirty memory pages fall below a threshold number of remaining dirty memory pages.

According to some examples, apparatus 800 may also include a policy component 822-3. Policy component 822-3 may be executed by circuitry 820 to select the first VM for the first live migration based on the predicted VM migration behavior satisfying one or more policies compared to other separately predicted VM migration behaviors of other VMs of the respective VMs. The first live migration is indicated in FIG. 8 as 1^{st} live migration 830. For these examples, the one or more policies may be included with policies 824-e (e.g., in a LUT). The one or more policies may include, but are not limited to, a first policy of least impact on a given VM fulfilling its respective workload during live migration compared to other VMs, a second policy based on a lowest amount of network bandwidth needed for live migration of the given VM compared to other VMs or a third policy of shortest time for the given VM to live migrate to the destination node compared to the other VMs.

In some examples, pattern component 822-1 may determine working set patterns for remaining respective VMs hosted by the source node based on the first VM being live migrated to the destination node and based on the remaining respective VMs separately executing one or more applications to fulfill respective workloads. For these examples, prediction component 822-2 may then predict a VM migration behavior for a second VM of the remaining respective VMs to the destination node based on a second working set pattern of the second VM determined by pattern component 822-1 and based on a second network bandwidth allocated for a second live migration of at least one of the remaining respective VMs to the destination node. The second network bandwidth allocated for the second live migration may be a combined network bandwidth of the first network bandwidth and a third network bandwidth allocated to the first VM prior to the first live migration of the first VM. Policy component 822-3 may then select the second VM for the second live migration based on the predicted VM migration behavior of the second VM satisfying the one or more policies compared to other separately predicted VM migration behaviors of other VMs of the remaining respective VMs. This second live migration is indicated in FIG. 8 as 2^{nd} live migration 840. Additional migrations indicated in FIG. 8 as Nth live migration 850 may be implemented in a similar manner as mentioned above for the second live migration.

In some examples, apparatus 800 may also include a borrow component 822-4. Borrow component 822-4 may be executed by circuitry 820 to borrow additional network bandwidth or computing resources for a second network bandwidth or computing resources allocated to other VMs of the respective VMs for executing one or more applications to fulfill respective workloads. For these examples, the borrowing of the additional network bandwidth may be based on prediction component 822-2 determining that the predicted VM migration behavior of the first VM indicates that QoS/SLA requirements may not be met with the currently allocated resources and then determining what additional allocations would be needed to meet the QoS/SLA requirements and indicating those additional allocations to borrow component 822-4. Also, once the additional network bandwidth or computing resources are borrowed, borrow component 822-4 may combine the borrowed additional network bandwidth or computing resources with current allocations for the first VM to enable remaining dirty memory pages and processor and input/output states to be copied to the destination node for the first VM to execute the first application to fulfill a first workload within a shutdown time threshold.

According to some examples, apparatus 800 may also include a reduction component 822-5. Reduction component 822-5 may be executed by circuitry 820 to reduce an amount of allocated processing resources for the first VM to execute the first application to fulfill the first workload to cause a reduced rate of dirty memory page generation such that the remaining dirty memory pages fall below the threshold number of remaining dirty memory pages. For these examples, reduction component 822-5 may reduce the amount of allocated processing resources responsive to prediction component 822-2 determining that the predicted VM migration behavior of the first VM for the first live migration indicates that the remaining dirty memory pages do not fall below the threshold number of remaining dirty memory pages.

Included herein is a set of logic flows representative of example methodologies for performing novel aspects of the disclosed architecture. While, for purposes of simplicity of explanation, the one or more methodologies shown herein are shown and described as a series of acts, those skilled in the art will understand and appreciate that the methodologies are not limited by the order of acts. Some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

A logic flow may be implemented in software, firmware, and/or hardware. In software and firmware embodiments, a logic flow may be implemented by computer executable instructions stored on at least one non-transitory computer readable medium or machine readable medium, such as an optical, magnetic or semiconductor storage. The embodiments are not limited in this context.

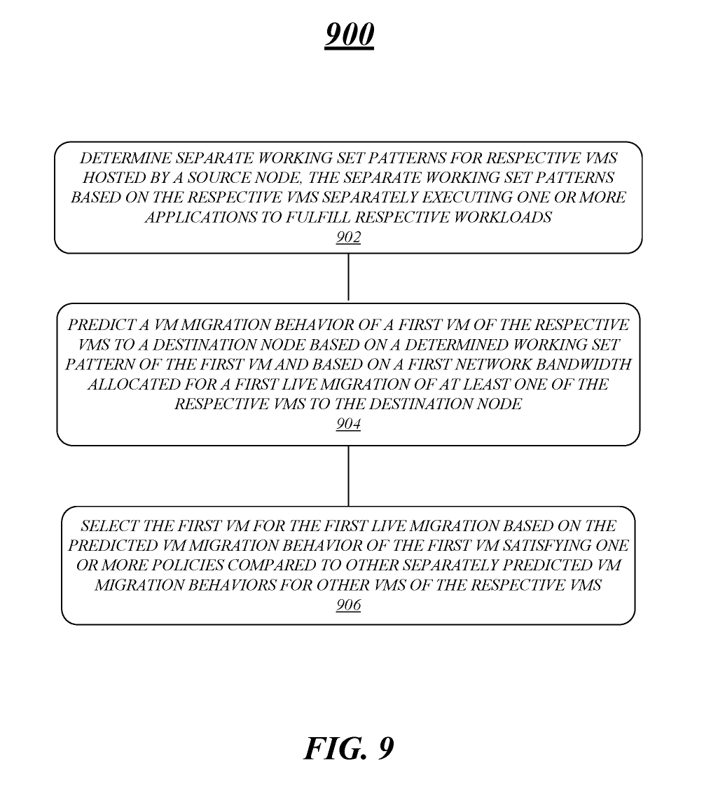

FIG. 9 illustrates an example of a logic flow 900. Logic flow 900 may be representative of some or all of the operations executed by one or more logic, features, or devices described herein, such as apparatus 800. More particularly, logic flow 900 may be implemented by at least pattern component 822-1, prediction component 822-2 or policy component 822-3.

According to some examples, logic flow 900 at block 902 may determine separate working set patterns for respective VMs hosted by a source node, the separate working set patterns based on the respective VMs separately executing one or more applications to fulfill respective workloads. For these examples, pattern component 822-1 may determine the separate working set patterns.

In some examples, logic flow 900 at block 904 may predict a VM migration behavior for a first live migration of a first VM of the respective VMs to a destination node based on a determined working set pattern of the first VM and based on a first network bandwidth allocated for a first live migration of at least one of the respective VMs to the destination. For these examples, prediction component 822-2 may predict the VM migration behavior for the first live migration of the first VM.

According to some examples, logic flow 900 at block 906 may select the first VM for the first live migration based on the predicted VM migration behavior of the first VM satisfying one or more policies compared to other separately predicted VM migration behaviors of other VMs of the respective VMs. For these examples, policy component 822-3 may select the first VM based on the predicted VM migration behavior of the first VM satisfying one or more policies compared to other separately predicted VM migration behaviors of other VMs of the respective VMs.

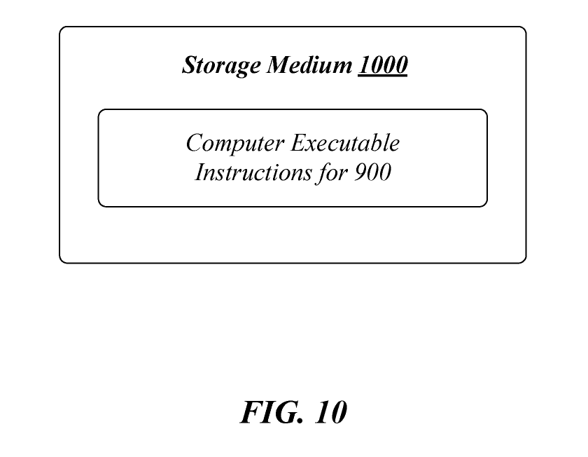

FIG. 10 illustrates an example of a storage medium 1000. Storage medium 1000 may comprise an article of manufacture. In some examples, storage medium 1000 may include any non-transitory computer readable medium or machine readable medium, such as an optical, magnetic or semiconductor storage. Storage medium 1000 may store various types of computer executable instructions, such as instructions to implement logic flow 900. Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

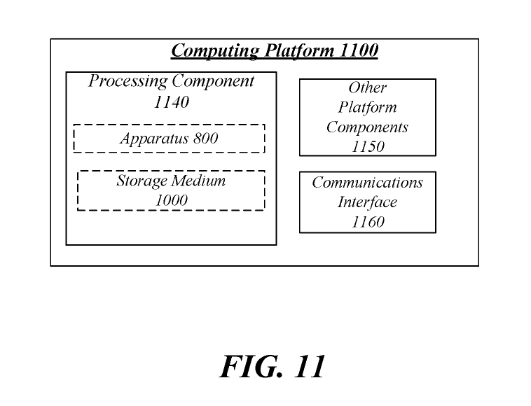

FIG. 11 illustrates an example computing platform 1100. In some examples, as shown in FIG. 11, computing platform 1100 may include a processing component 1140, other platform components 1150 or a communications interface 1160. According to some examples, computing platform 1100 may be implemented in a node/server. The node/server may be capable of coupling through a network to other nodes/servers and may be part of data center including a plurality of network connected nodes/servers arranged to host VMs.

According to some examples, processing component 1140 may execute processing operations or logic for apparatus 800 and/or storage medium 1000. Processing component 1140 may include various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, device drivers, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given example.

In some examples, other platform components 1150 may include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory), solid state drives (SSD) and any other type of storage media suitable for storing information.

In some examples, communications interface 1160 may include logic and/or features to support a communication interface. For these examples, communications interface 1160 may include one or more communication interfaces that operate according to various communication protocols or standards to communicate over direct or network communication links or channels. Direct communications may occur via use of communication protocols or standards described in one or more industry standards (including progenies and variants) such as those associated with the PCIe specification. Network communications may occur via use of communication protocols or standards such those described in one or more Ethernet standards promulgated by IEEE. For example, one such Ethernet standard may include IEEE 802.3. Network communication may also occur according to one or more OpenFlow specifications such as the OpenFlow Hardware Abstraction API Specification.

As mentioned above computing platform 1100 may be implemented in a server/node of a data center. Accordingly, functions and/or specific configurations of computing platform 1100 described herein, may be included or omitted in various embodiments of computing platform 1100, as suitably desired for a server/node.

The components and features of computing platform 1100 may be implemented using any combination of discrete circuitry, application specific integrated circuits (ASICs), logic gates and/or single chip architectures. Further, the features of computing platform 1100 may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It should be appreciated that the exemplary computing platform 1100 shown in the block diagram of FIG. 11 may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some examples may include an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The follow examples pertain to additional examples of technologies disclosed herein.

### Example 1

An example apparatus may include circuitry. The apparatus may also include a pattern component for execution by the circuitry to determine separate working set patterns for respective VMs hosted by a source node. The separate working set patterns may be based on the respective VMs separately executing one or more applications to fulfill respective workloads. The apparatus may also include a prediction component for execution by the circuitry to predict a VM migration behavior of a first VM of the respective VMs to a destination node based on a working set pattern of the first VM determined by the pattern component and based on a first network bandwidth allocated for a first live migration of at least one of the respective VMs to the destination node. The apparatus may also include a policy component for execution by the circuitry to select the first VM for the first live migration based on the predicted VM migration behavior of the first VM satisfying one or more policies compared to other separately predicted VM migration behaviors of other VMs of the respective VMs.

### Example 2

The apparatus of example 1, the one or more policies may include the policy component to select a given VM for the first migration based on at least one of a first policy of least impact on the given VM fulfilling its respective workload during live migration compared to other VMs, a second policy based on a lowest amount of the source node network bandwidth needed for live migration of the given VM compared to the other VMs or a third policy of shortest time for the given VM to live migrate to the destination node compared to the other VMs.

### Example 3

The apparatus of example 2, the policy component to select the given VM for the first migration may further include the policy component to select the given VM and one or more additional VMs for a parallel first live migration to the destination node based on the given VM and the one or more additional VMs having predicted first migration behaviors satisfying the first policy, the second policy, the third policy or a combination of the first, second or third policies as compared to remaining VMs not selected by the policy component for the parallel first live migration.

### Example 4

The apparatus of example 1, may include the pattern component to determine working set patterns for remaining respective VMs hosted by the source node based on the first VM being live migrated to the destination node and based on the remaining respective VMs separately executing one or more applications to fulfill respective workloads. For these examples the prediction component may predict a VM migration behavior of a second VM of the remaining respective VMs to the destination node based on a second working set pattern of the second VM determined by the pattern component and based on a second network bandwidth allocated for a second live migration of at least one of the remaining respective VMs to the destination node. The second network bandwidth allocated for the second live migration may be a combined network bandwidth of the first network bandwidth and a third network bandwidth allocated to the first VM prior to the first live migration of the first VM. Also for these examples, the policy component may select the second VM for the second live migration based on the predicted VM migration behavior of the second VM satisfying the one or more policies compared to the other separately predicted VM migration behaviors of other VMs of the remaining respective VMs.

### Example 5

The apparatus of example 1, the pattern component to determine separate working set patterns for respective VMs may include the pattern component to determine respective rates for which the respective VMs generate dirty memory pages as the respective VMs are separately executing one or more applications to fulfill respective workloads.

### Example 6

The apparatus of example 5, the prediction component to predict the VM migration behavior of the first VM for the live migration of the first VM to the destination node may include the working set pattern of the first VM determined by the pattern component used to determine how many copy iterations are needed to copy dirty memory pages to the destination node during the first live migration given the first network bandwidth allocated for the first live migration until remaining dirty memory pages fall below a threshold number of remaining dirty memory pages.

### Example 7

The apparatus of example 6, the threshold number may be based on copying remaining dirty memory pages and at least processor and input/output states to the destination node for the first VM to execute a first application to fulfill a first workload within a shutdown time threshold using the first network bandwidth allocated for the first live migration.

### Example 8

The apparatus of example 7, the prediction component may determine that the predicted VM migration behavior of the first VM for the first live migration indicates that the remaining dirty memory pages do not fall below the threshold number of remaining dirty memory pages. For these examples, the prediction component may determine what additional network bandwidth is needed to enable the remaining dirty memory pages to fall below the threshold number of remaining dirty memory pages. The apparatus may also include a borrow component for execution by the circuitry to borrow the additional network bandwidth from a second network bandwidth allocated to the other VMs of the respective VMs for executing one or more applications to fulfill respective workloads. Also for these examples, the borrow component may combine the borrowed additional network bandwidth with the first network bandwidth to enable remaining dirty memory pages and at least processor and input/output states to be copied to the destination node for the first VM to execute the first application to fulfill the first workload within the shutdown time threshold.

### Example 9

The apparatus of example 7, the prediction component may determine that the predicted VM migration behavior of the first VM for the first live migration indicates that the remaining dirty memory pages do not fall below the threshold number of remaining dirty memory pages. The apparatus may also include a reduction component for execution by the circuitry to reduce an amount of allocated processing resources for the first VM to execute the first application to fulfill the first workload to cause a reduced rate of dirty memory page generation such that the remaining dirty memory pages fall below the threshold number of remaining dirty memory pages.

### Example 10

The apparatus of example 7, the shutdown time threshold may be based on a requirement for the first VM to be stopped at the source node and restarted at the destination node within a given time period, the requirement set for meeting one or more QoS criteria or an SLA.

### Example 11

The apparatus of example 1, the source node and the destination node may be included in a data center arranged to provide IaaS, PaaS or SaaS.

### Example 12

The apparatus of example 1 may also include a digital display coupled to the circuitry to present a user interface view.

### Example 13

An example method may include determining, at a processor circuit, separate working set patterns for respective VMs hosted by a source node, the separate working set patterns based on the respective VMs separately executing one or more applications to fulfill respective workloads. The method may also include predicting a VM migration behavior for a first live migration of a first VM of the respective VMs to a destination node based on a determined working set pattern of the first VM and based on a first network bandwidth allocated for a first live migration of at least one of the respective VMs to the destination. The method may also include selecting the first VM for the first live migration based on the predicted VM migration behavior of the first VM satisfying one or more policies compared to other separately predicted VM migration behaviors of other VMs of the respective VMs.

### Example 14

The method of example 13, the one or more policies may include selecting a given VM for the first migration based on at least one of a first policy of least impact on the given VM fulfilling its respective workload during live migration compared to other VMs, a second policy based on a lowest amount of the source node network bandwidth needed for live migration of the given VM compared to the other VMs or a third policy of shortest time for the given VM to live migrate to the destination node compared to the other VMs.

### Example 15

The method of example 14, selecting the given VM for the first migration may further include selecting the given VM and one or more additional VMs for a parallel first live migration to the destination node based on the given VM and the one or more additional VMs having predicted first migration behaviors satisfying the first policy, the second policy, the third policy or a combination of the first, second or third policies as compared to remaining VMs not selected for the parallel first live migration.

### Example 16

The method of example 13 may also include determining working set patterns for remaining respective VMs hosted by the source node based on the first VM being live migrated to the destination node and based on the remaining respective VMs separately executing one or more applications to fulfill respective workloads. The method may also include predicting a VM migration behavior of a second VM of the remaining respective VMs to the destination node based on a determined second working set pattern of the second VM and based on a second network bandwidth allocated for a second live migration of at least one of the remaining respective VMs to the destination node. The second network bandwidth allocated for the second live migration may be a combined network bandwidth of the first network bandwidth and a third network bandwidth allocated to the first VM prior to the first live migration of the first VM. The method may also include selecting the second VM for the second live migration based on the predicted VM migration behavior of the second VM satisfying the one or more policies compared to the other separately predicted VM migration behaviors of other VMs of the remaining respective VMs.

### Example 17

The method of example 13, determining separate working set patterns for respective VMs may include determining respective rates for which the respective VMs generate dirty memory pages as the respective VMs are separately executing one or more applications to fulfill respective workloads.

### Example 18

The method of example 17, predicting the VM migration behavior of the first VM for the live migration of the first VM to the destination node may include the determined working set pattern of the first VM being used to determine how many copy iterations are needed to copy dirty memory pages to the destination node during the first live migration given the first network bandwidth allocated for the first live migration until remaining dirty memory pages fall below a threshold number of remaining dirty memory pages.

### Example 19

The method of example 18, the threshold number may be based on copying remaining dirty memory pages and at least processor and input/output states to the destination node for the first VM to execute a first application to fulfill a first workload within a shutdown time threshold using the first network bandwidth allocated for the first live migration.

### Example 20

The method of example 19 may include determining that the predicted VM migration behavior of the first VM for the first live migration indicates that the remaining dirty memory pages do not fall below the threshold number of remaining dirty memory pages. The method may also include determining what additional network bandwidth is needed to enable the remaining dirty memory pages to fall below the threshold number of remaining dirty memory pages. The method may also include borrowing the additional network bandwidth from a second network bandwidth allocated to the other VMs of the respective VMs for executing one or more applications to fulfill respective workloads. The method may also include combining the borrowed additional network bandwidth with the first network bandwidth to enable remaining dirty memory pages and at least processor and input/output states to be copied to the destination node for the first VM to execute the first application to fulfill the first workload within the shutdown time threshold.

### Example 21

The method of example 19 may include determining that the predicted VM migration behavior of the first VM for the first live migration indicates that the remaining dirty memory pages do not fall below the threshold number of remaining dirty memory pages. The method may also include reducing an amount of allocated processing resources for the first VM to execute the first application to fulfill the first workload to cause a reduced rate of dirty memory page generation such that the remaining dirty memory pages fall below the threshold number of remaining dirty memory pages.

### Example 22

The method of example 19, the shutdown time threshold may be based on a requirement for the first VM to be stopped at the source node and restarted at the destination node within a given time period, the requirement set for meeting one or more QoS criteria or an SLA.

### Example 23

The method of example 13, the source node and the destination node may be included in a data center arranged to provide IaaS, PaaS or SaaS.

### Example 24

An example at least one machine readable medium may include a plurality of instructions that in response to being executed by system at a computing platform may cause the system to carry out a method according to any one of examples 13 to 23.

### Example 25

An example apparatus may include means for performing the methods of any one of examples 13 to 23.

### Example 26

An example at least one machine readable medium may include a plurality of instructions that in response to being executed by a system may cause the system to determine separate working set patterns for respective VMs hosted by a source node. The separate working set patterns may be based on the respective VMs separately executing one or more applications to fulfill respective workloads. The instructions may also cause the system to predict a VM migration behavior for a first live migration of a first VM of the respective VMs to a destination node based on a determined working set pattern of the first VM and based on a first network bandwidth and processing resources allocated for a first live migration of at least one of the respective VMs to the destination. The instructions may also cause the system to select the first VM for the first live migration based on the predicted VM migration behavior of the first VM satisfying one or more policies compared to other separately predicted VM migration behaviors of other VMs of the respective VMs.

### Example 27

The at least one machine readable medium of example 26, the one or more policies may include selecting a given VM for the first migration based on at least one of a first policy of least impact on the given VM fulfilling its respective workload during live migration compared to other VMs, a second policy based on a lowest amount of the source node network bandwidth needed for live migration of the given VM compared to the other VMs or a third policy of shortest time for the given VM to live migrate to the destination node compared to the other VMs.

### Example 28

The at least one machine readable medium of example 27, the instructions to cause the system to select the given VM for the first migration may also include the instructions to cause the system to select the given VM and one or more additional VMs for a parallel first live migration to the destination node based on the given VM and the one or more additional VMs having predicted first migration behaviors satisfying the first policy, the second policy, the third policy or a combination of the first, second or third policies as compared to remaining VMs not selected for the parallel first live migration.

### Example 29

The at least one machine readable medium of example 26, the instructions may further cause the system to determine working set patterns for remaining respective VMs hosted by the source node based on the first VM being live migrated to the destination node and based on the remaining respective VMs separately executing one or more applications to fulfill respective workloads. The instructions may also cause the system to predict a VM migration behavior of a second VM of the remaining respective VMs to the destination node based on a determined second working set pattern of the second VM and based on a second network bandwidth and processing resources allocated for a second live migration of at least one of the remaining respective VMs to the destination node. The second network bandwidth and processing resources allocated for the second live migration may be a combined network bandwidth of the first network bandwidth and a third network bandwidth and processing resources allocated to the first VM prior to the first live migration of the first VM. The instructions may also cause the system to select the second VM for the second live migration based on the predicted VM migration behavior of the second VM satisfying the one or more policies compared to the other separately predicted VM migration behaviors of other VMs of the remaining respective VMs.

### Example 30

The at least one machine readable medium of example 26, the instructions to cause the system to determine separate working set patterns for respective VMs may include determining respective rates for which the respective VMs generate dirty memory pages as the respective VMs are separately executing one or more applications to fulfill respective workloads.

### Example 31

The at least one machine readable medium of example 30, the instructions to cause the system to predict the VM migration behavior of the first VM for the live migration of the first VM to the destination node may include the determined working set pattern of the first VM being used to determine how many copy iterations are needed to copy dirty memory pages to the destination node during the first live migration given the first network bandwidth and processing resources allocated for the first live migration until remaining dirty memory pages fall below a threshold number of remaining dirty memory pages.

### Example 32

The at least one machine readable medium of example 30, the threshold number may be based on copying remaining dirty memory pages and at least processor and input/output states to the destination node for the first VM to execute a first application to fulfill a first workload within a shutdown time threshold using the first network bandwidth allocated for the first live migration.

### Example 33

The at least one machine readable medium of example 32, the instructions may further cause the system to determine that the predicted VM migration behavior of the first VM for the first live migration indicates that the remaining dirty memory pages do not fall below the threshold number of remaining dirty memory pages. The instructions may also cause the system to determine what additional network bandwidth or processing resources is needed to enable the remaining dirty memory pages to fall below the threshold number of remaining dirty memory pages. The instructions may also cause the system to borrow the additional network bandwidth or processing resources from a second network bandwidth and processing resources allocated to the other VMs of the respective VMs for executing one or more applications to fulfill respective workloads. The instructions may also cause the system to combine the borrowed additional network bandwidth or processing resources with the first network bandwidth and processing resources to enable remaining dirty memory pages and at least processor and input/output states to be copied to the destination node for the first VM to execute the first application to fulfill the first workload within the shutdown time threshold.

### Example 34

The at least one machine readable medium of example 32, the instructions may further cause the system to determine that the predicted VM migration behavior of the first VM for the first live migration indicates that the remaining dirty memory pages do not fall below the threshold number of remaining dirty memory pages. The instructions may also cause the system to reduce an amount of allocated processing resources for the first VM to execute the first application to fulfill the first workload to cause a reduced rate of dirty memory page generation such that the remaining dirty memory pages fall below the threshold number of remaining dirty memory pages.

### Example 35

The at least one machine readable medium of example 32, the shutdown time threshold may be based on a requirement for the first VM to be stopped at the source node and restarted at the destination node within a given time period, the requirement set for meeting one or more QoS criteria or an SLA.

### Example 36

The at least one machine readable medium of example 26, the source node and the destination node may be included in a data center arranged to provide IaaS, PaaS or SaaS.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An apparatus comprising:
circuitry;
a pattern component for execution by the circuitry to determine separate working set patterns for respective virtual machines (VMs) hosted by a source node, the separate working set patterns based on the respective VMs separately executing one or more applications to fulfill respective workloads;
a prediction component for execution by the circuitry to predict a VM migration behavior of a first VM of the respective VMs to a destination node based on a working set pattern of the first VM determined by the pattern component and based on a first network bandwidth allocated for a first live migration of at least one of the respective VMs to the destination node; and
a policy component for execution by the circuitry to select the first VM for the first live migration based on the predicted VM migration behavior of the first VM satisfying one or more policies compared to other separately predicted VM migration behaviors of other VMs of the respective VMs.

2. The apparatus of claim 1, the one or more policies comprises the policy component to select a given VM for the first migration based on at least one of a first policy of least impact on the given VM fulfilling its respective workload during live migration compared to other VMs, a second policy based on a lowest amount of the source node network bandwidth needed for live migration of the given VM compared to the other VMs or a third policy of shortest time for the given VM to live migrate to the destination node compared to the other VMs.

3. The apparatus of claim 1, comprising:
the pattern component to determine working set patterns for remaining respective VMs hosted by the source node based on the first VM being live migrated to the destination node and based on the remaining respective VMs separately executing one or more applications to fulfill respective workloads;
the prediction component to predict a VM migration behavior of a second VM of the remaining respective VMs to the destination node based on a second working set pattern of the second VM determined by the pattern component and based on a second network bandwidth allocated for a second live migration of at least one of the remaining respective VMs to the destination node, the second network bandwidth allocated for the second live migration is a combined network bandwidth of the first network bandwidth and a third network bandwidth allocated to the first VM prior to the first live migration of the first VM; and
the policy component to select the second VM for the second live migration based on the predicted VM migration behavior of the second VM satisfying the one or more policies compared to the other separately predicted VM migration behaviors of other VMs of the remaining respective VMs.

4. The apparatus of claim 1, comprising the pattern component to determine separate working set patterns for respective VMs comprises the pattern component to determine respective rates for which the respective VMs generate dirty memory pages as the respective VMs are separately executing one or more applications to fulfill respective workloads.

5. The apparatus of claim 4, the prediction component to predict the VM migration behavior of the first VM for the live migration of the first VM to the destination node comprises the working set pattern of the first VM determined by the pattern component used to determine how many copy iterations are needed to copy dirty memory pages to the destination node during the first live migration given the first network bandwidth allocated for the first live migration until remaining dirty memory pages fall below a threshold number of remaining dirty memory pages.

6. The apparatus of claim 5, the threshold number is based on copying remaining dirty memory pages and at least processor and input/output states to the destination node for the first VM to execute a first application to fulfill a first workload within a shutdown time threshold using the first network bandwidth allocated for the first live migration.

7. The apparatus of claim 6, comprising:
the prediction component to determine that the predicted VM migration behavior of the first VM for the first live migration indicates that the remaining dirty memory pages do not fall below the threshold number of remaining dirty memory pages;
the prediction component to determine what additional network bandwidth is needed to enable the remaining dirty memory pages to fall below the threshold number of remaining dirty memory pages;
a borrow component for execution by the circuitry to borrow the additional network bandwidth from a second network bandwidth allocated to the other VMs of the respective VMs for executing one or more applications to fulfill respective workloads; and
the borrow component to combine the borrowed additional network bandwidth with the first network bandwidth to enable remaining dirty memory pages and at least processor and input/output states to be copied to the destination node for the first VM to execute the first application to fulfill the first workload within the shutdown time threshold.

8. The apparatus of claim 6, comprising:
the prediction component to determine that the predicted VM migration behavior of the first VM for the first live migration indicates that the remaining dirty memory pages do not fall below the threshold number of remaining dirty memory pages; and
a reduction component for execution by the circuitry to reduce an amount of allocated processing resources for the first VM to execute the first application to fulfill the first workload to cause a reduced rate of dirty memory page generation such that the remaining dirty memory pages fall below the threshold number of remaining dirty memory pages.

9. The apparatus of claim 6, the shutdown time threshold based on a requirement for the first VM to be stopped at the source node and restarted at the destination node within a given time period, the requirement set for meeting one or more quality of service (QoS) criteria or a service level agreement (SLA).

10. The apparatus of claim 1, comprising a digital display coupled to the circuitry to present a user interface view.

11. A method comprising:
determining, at a processor circuit, separate working set patterns for respective virtual machines (VMs) hosted by a source node, the separate working set patterns based on the respective VMs separately executing one or more applications to fulfill respective workloads;
predicting a VM migration behavior for a first live migration of a first VM of the respective VMs to a destination node based on a determined working set pattern of the first VM and based on a first network bandwidth allocated for a first live migration of at least one of the respective VMs to the destination; and
selecting the first VM for the first live migration based on the predicted VM migration behavior of the first VM satisfying one or more policies compared to other separately predicted VM migration behaviors of other VMs of the respective VMs.

12. The method of claim 11, the one or more policies comprises selecting a given VM for the first migration based on at least one of a first policy of least impact on the given VM fulfilling its respective workload during live migration compared to other VMs, a second policy based on a lowest amount of the source node network bandwidth needed for live migration of the given VM compared to the other VMs or a third policy of shortest time for the given VM to live migrate to the destination node compared to the other VMs.

13. The method of claim 11, comprising:
determining working set patterns for remaining respective VMs hosted by the source node based on the first VM being live migrated to the destination node and based on the remaining respective VMs separately executing one or more applications to fulfill respective workloads;
predicting a VM migration behavior of a second VM of the remaining respective VMs to the destination node based on a determined second working set pattern of the second VM and based on a second network bandwidth allocated for a second live migration of at least one of the remaining respective VMs to the destination node, the second network bandwidth allocated for the second live migration is a combined network bandwidth of the first network bandwidth and a third network bandwidth allocated to the first VM prior to the first live migration of the first VM; and
selecting the second VM for the second live migration based on the predicted VM migration behavior of the second VM satisfying the one or more policies compared to the other separately predicted VM migration behaviors of other VMs of the remaining respective VMs.

14. The method of claim 11, determining separate working set patterns for respective VMs comprises determining respective rates for which the respective VMs generate dirty memory pages as the respective VMs are separately executing one or more applications to fulfill respective workloads.

15. The method of claim 14, predicting the VM migration behavior of the first VM for the live migration of the first VM to the destination node comprises the determined working set pattern of the first VM being used to determine how many copy iterations are needed to copy dirty memory pages to the destination node during the first live migration given the first network bandwidth allocated for the first live migration until remaining dirty memory pages fall below a threshold number of remaining dirty memory pages.

16. (canceled)

17. (canceled)

18. At least one machine readable medium comprising a plurality of instructions that in response to being executed by a system cause the system to:
determine separate working set patterns for respective virtual machines (VMs) hosted by a source node, the separate working set patterns based on the respective VMs separately executing one or more applications to fulfill respective workloads;
predict a VM migration behavior for a first live migration of a first VM of the respective VMs to a destination node based on a determined working set pattern of the first VM and based on a first network bandwidth and processing resources allocated for a first live migration of at least one of the respective VMs to the destination; and
select the first VM for the first live migration based on the predicted VM migration behavior of the first VM satisfying one or more policies compared to other separately predicted VM migration behaviors of other VMs of the respective VMs.

19. The at least one machine readable medium of claim 18, the one or more policies comprises selecting a given VM for the first migration based on at least one of a first policy of least impact on the given VM fulfilling its respective workload during live migration compared to other VMs, a second policy based on a lowest amount of the source node network bandwidth needed for live migration of the given VM compared to the other VMs or a third policy of shortest time for the given VM to live migrate to the destination node compared to the other VMs.

20. The at least one machine readable medium of claim 19, the instructions to cause the system to select the given VM for the first migration further comprises the instructions to cause the system to select the given VM and one or more additional VMs for a parallel first live migration to the destination node based on the given VM and the one or more additional VMs having predicted first migration behaviors satisfying the first policy, the second policy, the third policy or a combination of the first, second or third policies as compared to remaining VMs not selected for the parallel first live migration.

21. The at least one machine readable medium of claim 18, the instructions to cause the system to determine separate working set patterns for respective VMs comprises determining respective rates for which the respective VMs generate dirty memory pages as the respective VMs are separately executing one or more applications to fulfill respective workloads.

22. The at least one machine readable medium of claim 21, the instructions to cause the system to predict the VM migration behavior of the first VM for the live migration of the first VM to the destination node comprises the determined working set pattern of the first VM being used to determine how many copy iterations are needed to copy dirty memory pages to the destination node during the first live migration given the first network bandwidth and processing resources allocated for the first live migration until remaining dirty memory pages fall below a threshold number of remaining dirty memory pages.

23. The at least one machine readable medium of claim 21, the threshold number is based on copying remaining dirty memory pages and at least processor and input/output states to the destination node for the first VM to execute a first application to fulfill a first workload within a shutdown time threshold using the first network bandwidth allocated for the first live migration.

24. The at least one machine readable medium of claim 23, the instructions to further cause the system to:
determine that the predicted VM migration behavior of the first VM for the first live migration indicates that the remaining dirty memory pages do not fall below the threshold number of remaining dirty memory pages;
determine what additional network bandwidth or processing resources is needed to enable the remaining dirty memory pages to fall below the threshold number of remaining dirty memory pages;
borrow the additional network bandwidth or processing resources from a second network bandwidth and processing resources allocated to the other VMs of the respective VMs for executing one or more applications to fulfill respective workloads; and
combine the borrowed additional network bandwidth or processing resources with the first network bandwidth and processing resources to enable remaining dirty memory pages and at least processor and input/output states to be copied to the destination node for the first VM to execute the first application to fulfill the first workload within the shutdown time threshold.

25. The at least one machine readable medium of claim 23 the instructions to further cause the system to:
determine that the predicted VM migration behavior of the first VM for the first live migration indicates that the remaining dirty memory pages do not fall below the threshold number of remaining dirty memory pages; and
reduce an amount of allocated processing resources for the first VM to execute the first application to fulfill the first workload to cause a reduced rate of dirty memory page generation such that the remaining dirty memory pages fall below the threshold number of remaining dirty memory pages.

26. The method of claim 15, the threshold number is based on copying remaining dirty memory pages and at least processor and input/output states to the destination node for the first VM to execute a first application to fulfill a first workload within a shutdown time threshold using the first network bandwidth allocated for the first live migration.

27. The method of claim 16, comprising:
determining that the predicted VM migration behavior of the first VM for the first live migration indicates that the remaining dirty memory pages do not fall below the threshold number of remaining dirty memory pages; and
reducing an amount of allocated processing resources for the first VM to execute the first application to fulfill the first workload to cause a reduced rate of dirty memory page generation such that the remaining dirty memory pages fall below the threshold number of remaining dirty memory pages.
